(19) United States
(12) Patent Application Publication
(10) Pub. No.: US 2021/0366048 A1
(43) Pub. Date: Nov. 25, 2021

(54) METHODS AND SYSTEMS FOR REACTING TO LOSS REPORTING DATA

(71) Applicant: STATE FARM MUTUAL AUTOMOBILE INSURANCE COMPANY, Bloomington, IL (US)

(72) Inventors: John Westhues, Normal, IL (US); Leann Dionesotes, Bloomington, IL (US); David Ruby, Normal, IL (US); John Dillard, Bloomington, IL (US)

(21) Appl. No.: 16/411,630

(22) Filed: May 14, 2019

Related U.S. Application Data
(60) Provisional application No. 62/671,263, filed on May 14, 2018.

(51) Int. Cl. G06Q 40/08; G06N 20/00; G06Q 10/00

(52) U.S. Cl. CPC G06Q 40/08; G06Q 10/20; G06N 20/00

(57) ABSTRACT

A method for classifying total loss based on claim characteristics may include training a machine learning model using labeled data to classify a loss report, receiving a loss report associated with a policy, analyzing the loss report using the trained model to classify the loss report into a category, and storing an indication of total loss in association with the loss report when the category is a total loss category. A method for automating loss report taking may include receiving loss report data and telephony data from a user, correlating the user to a policy and a profile, determining a preferred language of the user and displaying a prepopulated loss report and a loss report word track in the preferred language of the user to a customer support user, wherein the prepopulated loss report and loss report word track are interpolated into predetermined locations in a loss report template.

### CROSS-REFERENCE TO RELATED APPLICATION

The present application claims priority to U.S. Application No. 62/671,263, filed May 14, 2018. The priority application, U.S. 62/671,263 is hereby incorporated by reference.

### FIELD OF THE DISCLOSURE

The present disclosure is directed to reacting to loss reporting data to accurately predict total loss events, automate customer identification and/or issue identification, and validating loss report information. More specifically, the present disclosure is directed to techniques for training a machine learning model to classify a loss report with respect to a set of categories, displaying localized messages to users based on user correlation using telephony data and loss report data, and identifying discrepancies across multiple steps of a loss report workflow.

### BACKGROUND

In various applications a need exists to quickly and accurately identify total losses related to vehicle insurance claims. Traditionally, auto claim handlers have collected information from policyholders and analyzed that information to determine whether a damaged vehicle represents a total loss, or not. For example, a policyholder may be involved in an accident, and may provide an insurer with written and/or oral documentation relating to the incident (e.g., the vehicle make and model, year, mileage, etc.). Next, an auto claim handler may manually review the provided information, and make a determination based on the claim handler's experience.

The varied experience of claim handlers is a problem in the prior art. Claim handlers to not have the technical ability to analyze all past claims in a very short time (e.g., in microseconds). Claim handlers' lack of experience, cognitive bias, fatigue, etc. may lead them to make errors in judgment as to whether a loss is total. As such, a need exists for computerized methods and systems of identifying total losses related to vehicle insurance claims, wherein the methods and systems can be continuously trained on new data, operate around the clock, and predict total loss results that are repeatable and quantifiable.

### BRIEF SUMMARY

The present disclosure generally relates to systems and methods for reacting to loss reporting data. Embodiments of exemplary systems and computer-implemented methods are summarized below. The methods and systems summarized below may include additional, fewer, or alternate components, functionality, and/or actions, including those discussed elsewhere herein.

In one aspect, a method for classifying total loss based on claim characteristics, may include training, using a labeled data set, a machine learning model to classify a loss report with respect to a set of categories, receiving a user loss report associated with a policy, analyzing the user loss report using the trained machine learning model to classify the user loss report with respect to one of the set of categories, and, when the one of the set of categories corresponds to a total loss category, storing an indication of total loss in association with the loss report in an electronic database.

In another aspect, a method for automating loss report taking from a user may include receiving a loss report data set and a telephony data set from the user, correlating the user to a set of policies and a user profile based on the telephony data set and the loss report data set, determining a preferred language of the user based on the user profile, and displaying, in a display device viewable by a customer support user, a prepopulated loss report and at least one loss report word track written in the preferred language of the user, wherein the prepopulated loss report and at least one loss report word track are interpolated into predetermined locations in a loss report template.

### BRIEF DESCRIPTION OF THE DRAWINGS

The figures described below depict various aspects of the system and methods disclosed therein. It should be understood that each figure depicts one embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and instrumentalities shown, wherein:

FIG. 1 depicts an example environment in which the methods and systems described herein may operate to perform their respective functions, according to some embodiments,

FIG. 2 depicts a flow diagram of using a trained machine learning model analyzing auto claim data to predict total loss,

FIG. 3 depicts an example graphical user interface for a loss report data collection application, according to an embodiment; and

FIG. 4 depicts a flow diagram for handling completion of a loss report, according to an embodiment.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The embodiments described herein relate to, inter alia, techniques for training a machine learning model to classify a loss report with respect to a set of categories, displaying localized messages to users based on user correlation using telephony data and loss report data, and identifying discrepancies across multiple steps of a loss report workflow. More specifically, in some embodiments, machine learning techniques are used to train a model to classify a loss report with respect to a set of categories. Such a model may be trained using a set of labeled training data, wherein each item in the set of labeled training data includes a historical loss report, and a corresponding indication of whether the historical loss report is a total loss, or not a total loss. The indications of total loss and not a total loss may be two elements comprising the set of categories. That is, the model may be trained to classify the loss report into a set of categories, wherein the set of categories comprises “total loss” and “not a total loss.” It should be appreciated that additional categories may be used, such as zero and one and/or Boolean values. The labels may be represented in Boolean fashion or as continuous values. The set of categories may, in some cases, be a set of continuous values.

In some embodiments, localized messages are displayed to a customer service user based on correlating a data set of a user to other data sets using telephony data and/or loss report data. For example, a telephony integration system may include instructions for analyzing telephony data of a caller to the telephony integration system to locate a profile of the caller. The profile of the caller may be used to access a set of policies related to the caller. In some cases, the caller may enter an identification code that may be correlated to the profile of the caller. In other cases, the telephone number of the caller may be used to locate the profile of the caller. It should be appreciated that any suitable means of identifying a user may be used to correlate the data set of the user to the other data sets.

Once the set of policies and/or profile of the caller are located, the method may further include determining the preferred language of the caller (e.g., Spanish) by, for example, analyzing the profile of the caller. Next, a loss report may be displayed in a display of the telephony integration system, which is viewable by the customer service user. The loss report displayed may be an in-progress report, in which entry fields (defined herein as user interface widgets such as input boxes, check boxes, dropdown boxes, electronic forms, etc.) are already completed, or a blank loss report, wherein entry fields contain no values. The loss report may include textual prompts corresponding to each entry field, and the textual prompts may be automatically displayed in the preferred language of the user, via localization. In an embodiment, the values of entry fields corresponding to a loss report may be stored in an electronic database, in association with the user. A loss report template may also be stored in an electronic database.

In response to an indication that the user wants to complete a particular loss report (e.g., an auto loss report), a template corresponding to the report type may be selected from the electronic database and displayed in the user's preferred language. The template may be stored in the user's preferred language, or localized at runtime. A user may indicate that he or she wants to complete a loss report already in-progress, in which case the values corresponding to that loss report may be retrieved from the electronic database and interpolated into the template prior to display.

In some embodiments, indications of discrepancies and/or indications of incomplete data may be displayed to a user within a loss reporting navigation panel. The loss reporting navigation panel may facilitate a user's entry of information related to an auto loss and/or auto claim into entry fields in a loss report template, as described above. The loss report may be organized into a series of multiple steps in a loss report entry workflow, wherein each step may relate to the collection of a discrete set of information (e.g., personal information, accident information, policy information, etc.). The template may include validation logic for identifying discrepancies and/or across multiple steps of a loss report workflow.

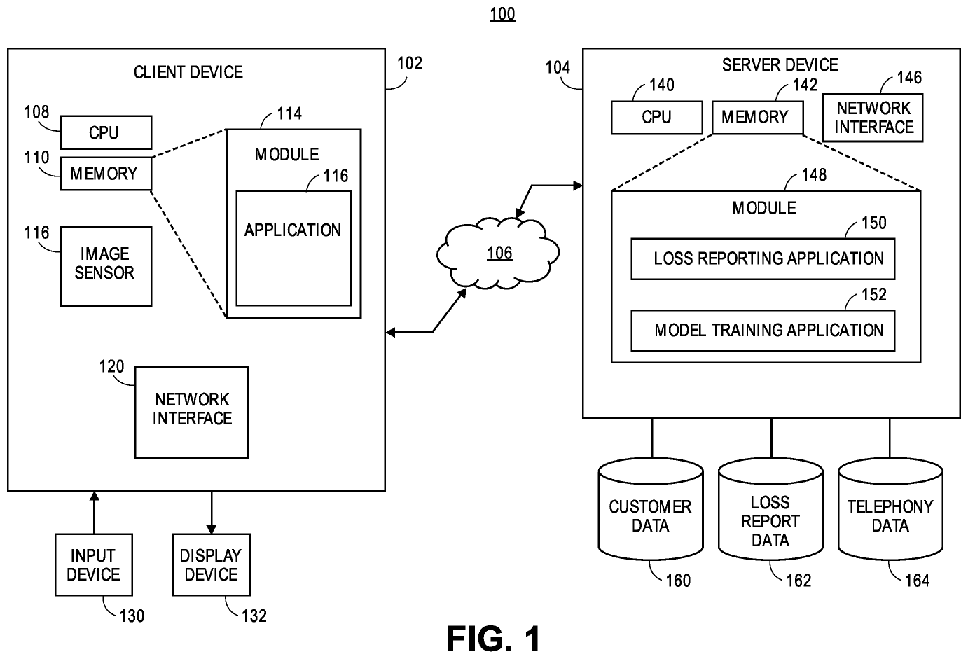

FIG. 1 depicts an example environment 100 in which the methods and systems described herein may be implemented. The environment 100 includes a client device 102 and a server device 104. The client device 102 and the server device 104 are communicatively coupled via a network 106, in the depicted embodiment. The client device 102 may access/utilize services provided by the server device 104. Such services may include machine learning (ML) model training and/or use, querying for historical claim data, processing electronic form submissions, performing telephony data searches, querying for word track data, querying for template data and localization data, serving web pages with dynamic elements (e.g., progress bars). The client device 102 may, in some embodiments, include one or more of the foregoing list of services. The server device 104 may be operated by a customer service user, whereas the client device 102 may be operated by a customer. While FIG. 1 shows only a single client device 102, it is understood that multiple different client devices (of different entities and/or users), each similar to the client device 102, may be in remote communication with the server device 104 via the network 106 and/or one or more other networks. The network 106 may be a single communication network, or may include multiple communication networks of one or more types (e.g., one or more wired and/or wireless local area networks (LANs), and/or one or more wired and/or wireless wide area networks (WANs) such as the Internet). The network 106 may comprise any type or types of suitable network(s).

The client device 102 may be a laptop computer, desktop computer, tablet, smartphone, wearable device, or any other suitable type of personal and/or mobile computing device. Alternatively, the client device 102 may be a relatively “dumb” node or terminal, such as an IoT device with little memory and/or processing power. The client device 102 may include a central processing unit (CPU) 108. While referred to in the singular, the CPU 108 may include any suitable number of processors of one or more types (e.g., one or more CPUs, graphics processing units (GPUs), cores, etc.). In the embodiment of FIG. 1, the client device 102 may also include a random access memory (RAM) 110, a module 114, an application 116, and a network interface 120. The module 114 may include one or more persistent memories (e.g., a hard drive and/or solid state memory) and may store data used by and/or output by application 116.

Generally, the CPU 108 may be configured to execute software instructions stored in the module 114, which may be loaded into the RAM 110. The module 114 may contain software instructions used to launch, initialize, and/or execute a trained ML model. The software instructions may access (i.e., read data from and/or write data to) the one or more persistent memories via the module 114 and the application 116 as needed. Portions of the software instructions and/or data may be loaded into the RAM 110 when the CPU 108 executes the software instructions comprising the application 116. For example, the application 116 may collect data from a user via an input device 130 and/or a display device 132. The application 116 may execute a trained ML model received via the network 106. The application 116 may include instructions for saving data to electronic databases local to the client device 102 or remote devices. The application 116 may include instructions comprising web pages and dynamic content (e.g., HTML, JavaScript, Cascading Style Sheets (CSS), etc.).

Further, the software instructions may load data generated by the image sensor 116 into the RAM 110, and may save the loaded data to persistent memory. Image sensor 116 may be configured to detect and convey physical measurement data, including without limitation: photographic (video or still images), infrared, speed, temperature, audio, acceleration, humidity, atmospheric pressure, and/or other physical measurement data. The image sensor 116 may generate digital data in a standard file encoding and/or compressed file format, and may capture data automatically or upon request.

The server device 104 may be located remotely from the client device 102, and the server device 104 may be an individual server, or may include a group or cluster of multiple servers. The server device 104 may be operated in a cloud computing and/or virtualized computing environment. Like the client device 102, the server device 104 may contain a CPU 140, which includes one or more processors, a RAM 142, and a network interface 146. Additionally, the server device 104 may include a module 148, in which software instructions may be stored (e.g., a loss reporting application 150 and a model training application 152). Generally, the model training application 152 may be used to train ML models.

In general, training ML models may include establishing a network architecture, or topology, and adding layers that may be associated with one or more activation functions (e.g., a rectified linear unit, softmax, etc.), loss functions and/or optimization functions. Multiple different types of artificial neural networks may be employed, including without limitation, recurrent neural networks, convolutional neural networks, and deep learning neural networks. Data sets used to train the artificial neural network(s) may be divided into training, validation, and testing subsets; these subsets may be encoded in an N-dimensional tensor, array, matrix, or other suitable data structures. Training may be performed by iteratively training the network using labeled training samples. Training of the artificial neural network may produce byproduct weights, or parameters which may be initialized to random values. The weights may be modified as the network is iteratively trained, by using one of several gradient descent algorithms, to reduce loss and to cause the values output by the network to converge to expected, or “learned”, values. In an embodiment, a regression neural network may be selected which lacks an activation function, wherein input data may be normalized by mean centering, to determine loss and quantify the accuracy of outputs. Such normalization may use a mean squared error loss function and mean absolute error. The artificial neural network model may be validated and cross-validated using standard techniques such as hold-out, K-fold, etc. In some embodiments, multiple artificial neural networks may be separately trained and operated, and/or separately trained and operated in conjunction. In another embodiment, a Bayesian model may be used to train the ML model.

In an embodiment, the ML model may include an artificial neural network (ANN) having an input layer, one or more hidden layers, and an output layer. Each of the layers in the ANN may include an arbitrary number of neurons. The plurality of layers may chain neurons together linearly and may pass output from one neuron to the next, or may be networked together such that the neurons communicate input and output in a non-linear way. In general, it should be understood that many configurations and/or connections of ANNs are possible. In an embodiment, the input layer may correspond to input parameters that are numerical facts, such as the age and/or number of years of work experience of a person, or to other types of data such as data from the loss report. The input layer may correspond to a large number of input parameters (e.g., one million inputs), in some embodiments, and may be analyzed serially or in parallel. Further, various neurons and/or neuron connections within the ANN may be initialized with any number of weights and/or other training parameters. Each of the neurons in the hidden layers may analyze one or more of the input parameters from the input layer, and/or one or more outputs from a previous one or more of the hidden layers, to generate a decision or other output. The output layer may include one or more outputs, each indicating a prediction. In some embodiments and/or scenarios, the output layer includes only a single output.

For example, a neuron may correspond to one of the neurons in the hidden layers. Each of the inputs to the neuron may be weighted according to a set of weights W₁ through Wᵢ, determined during the training process (for example, if the neural network is a recurrent neural network) and then applied to a node that performs an operation α. The operation α may include computing a sum, a difference, a multiple, or a different operation. In some embodiments weights are not determined for some inputs. In some embodiments, neurons of weight below a threshold value may be discarded/ignored. The sum of the weighted inputs, r₁, may be input to a function which may represent any suitable functional operation on r₁. The output of the function may be provided to a number of neurons of a subsequent layer or as an output of the ANN.

In the embodiment of FIG. 1, the server device 104 is coupled to a customer data 160, a loss report data 162, and a telephony data 164 which comprise, respectively: data related to customers, data related to loss reports, and data related to telephony.

### I. Total Loss Prediction

In operation, the server device 104 may train an ML model according to the principles described above. The ML model may be trained iteratively and may be tested to determine which model is most accurate and/or efficient on a given set of labeled loss reporting historical data. Creating and/or curation of the training data may be performed manually. In one embodiment, a second model may be constructed which analyzes certain inputs from the historical loss reporting data known to be highly probative of whether a vehicle is a total loss in addition to, or lieu of, the trained ML model. For example, an algorithmic approach may analyze whether the estimated cost of repairs exceeds the vehicle's actual cash value, whether the vehicle can be safely repaired, and/or any applicable state regulations for damage severity requiring a total loss declaration. In an embodiment, a database of unique vehicle types (e.g., makes, models, etc.) labeled by respective actual cash value may be used as a training input to an ML model.

The ML model may be trained by iteratively adjusting the weights of an ML model such as a neural network, using training input to “teach” the model to determine actual cost of repairs. For example, a training data set may include a set of historical claims for repairing pickup trucks, labeled by cost of repairs. The ML model may be shown examples of damaged pickup trucks, including the costs of repair. After many iterations, the model may be able to accurately predict the cost of repair of a pickup truck provided an image that the ML model has not seen previously. The output predicting the cost of repair may be compared to the actual cash value of the damaged pickup to determine which is greater. If the cost of repair exceeds the cash value, the damage may be considered a total loss. In another embodiment, images of damaged pickup trucks may be labeled by whether the pickup trucks represent a total loss, or not. In that case, a model may be trained to directly predict total loss/not a total loss based on an image of a pickup truck that the model had not previously seen. It should be appreciated that the foregoing training strategies may be combined, and that more complex training scenarios/combinations are envisioned.

Once an ML model has been trained, the server device 104 may receive a loss report via the network 106. The loss report may be received and/or retrieved by the loss reporting application 150. The loss reporting application 150 may retrieve a trained ML model from the loss report data 162, and the loss reporting application 150 may execute the trained ML model using the loss report as input to the trained ML model. The trained ML model may output an indication of whether the loss report corresponds to a total loss, or not. As stated, the indication of total loss may be a continuous or Boolean value. Based on the indication of total loss, a user of the client device 102 may be notified via the network 106. The notification may include the indication of total loss, in addition to other data (e.g., a prose explanation of the result).

When the ML model determines that the loss report includes a total loss event, the loss reporting application 150 and/or the application 116 may present (e.g., via the display device 132) the user of client device 102 with one or more output indicating one or more of the following steps: 1) preparing the vehicle identified in the loss report for salvage, 2) transferring the title of the vehicle identified in the loss report to the proprietor/insurer of the methods and systems disclosed herein, or 3) updating a policy associated with the user/insured, based on the policy and/or user identifiers in the loss report. In another embodiment, the trained ML may be executed in module 114 of client device 102, and server 104 may not be used. Facilitating ML models that may run in client device 102 may allow customer service users to make instantaneous loss reporting determinations with respect to total loss while working in the field. Such field-based capabilities have not been possible historically.

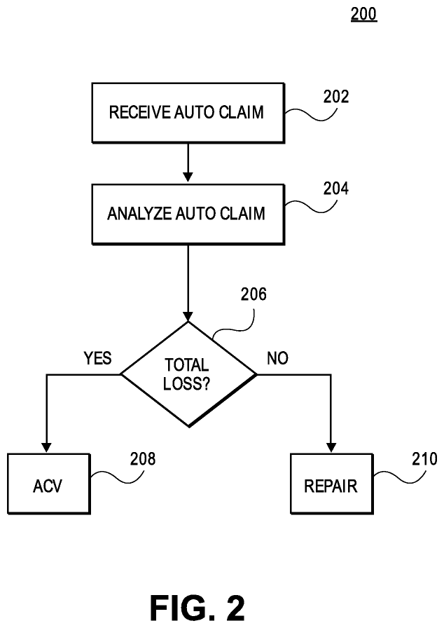

FIG. 2 depicts a block diagram of a machine learning model training method 200. The method 200 may include receiving an auto claim (block 202). The auto claim may correspond to a loss report entered into an application (e.g., the application 116) or taken by a telephone operator (e.g., a customer support user of loss reporting application 150). That is, in some embodiments, the loss report may be taken over the phone by a customer service user who also performs the data entry. The method 200 may include analyzing the auto claim by, for example, passing the information in the auto claim (e.g., the vehicle information, user information, policy information, etc.) to a trained machine learning model (block 204). The output of the trained machine learning model may be further analyzed in the method 200 to determine whether the loss includes a total loss (block 206). When the loss represents a total loss, then the method 200 may include offering the actual cash value of the vehicle to the user (block 208). When the loss does not represent a total loss, then the method 200 may include offering a repair option to the user (block 210). In some embodiments, wherein total loss is represented by a non-Boolean value, the method 200 may use a cutoff value at block 206 to determine whether the loss is total. As noted above, the determination of total loss may be used in a further computation, such as a vehicle salvage request, title transfer to an insurer, etc.

### II. Reacting to Loss Report Data

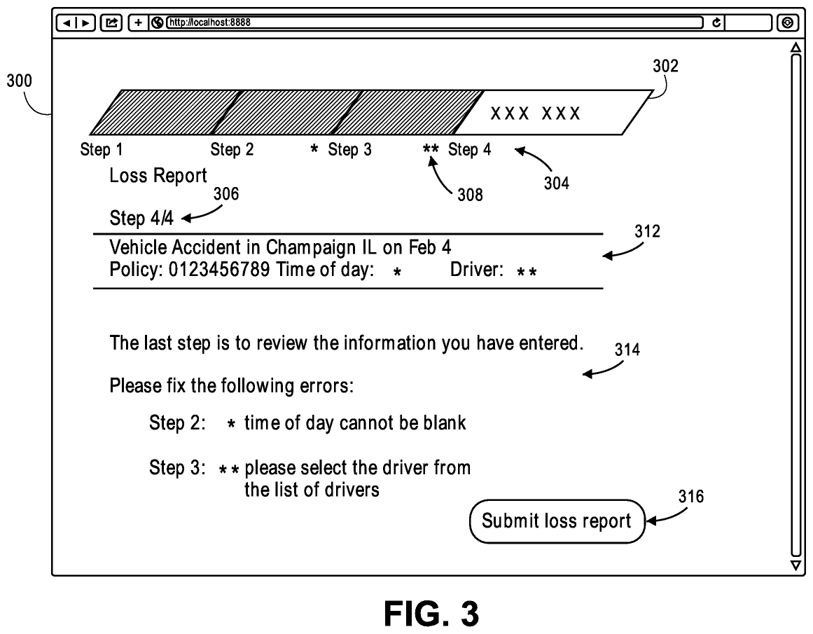

FIG. 3 depicts an example graphical user interface (GUI) 300 for a loss report data collection application, according to an embodiment. The GUI 300 may include a progress bar 302 including a plurality of steps 304. The GUI 300 may include a progress indicator 306 depicting the current step as a percentage of the total number of steps. The numerator of the percentage may correspond to the value depicted in the progress bar 302. The GUI 300 may include a status area 312 depicting a summary of the loss report (e.g., an accident time and location), information related to the user (e.g., a policy number), and an error indicator 308 relating to any entry fields that are incomplete and/or inaccurate. The GUI 300 may include an action area 314 including a textual explanation of the status of the overall loss report, including any validation errors, and one or more entry fields for navigating the loss report (e.g., moving between steps and/or amongst validation errors) and submitting the loss report. The current step may be the step that the user is currently visiting. The current step may be changed by the user visiting a step. The visited step may be the current step or another step in the workflow.

The GUI 300 may appear in a display device (e.g., a computer screen) of the server device 104. There, the GUI 300 may be accessed by a customer service user who may take information over the phone and/or via network 106 from a user. The GUI 300 may be generated by an application and/or instructions in module 148. Validation errors may be generated by a series of rules that reside in the loss report data 162. The rules may be applied to an application executing in the server device 104 in a single-page application (e.g., in a JavaScript web applications framework). In an embodiment, the GUI 300 may be accessible by a user (e.g., a policyholder) in the client device 102 (e.g., via application 116). Therefore, the GUI 300 may enforce data validity at all entry points, ensuring that only valid data is allowed to be collected and used by claim handlers analyzing loss reports. The progress bar 302 is helpful to a policyholder user and a customer service user by informing both users whether the loss report contains validation errors and by informing both users of their respective overall progress in completing the loss report. All of the components of GUI 300 may be displayed dynamically and updated automatically as the GUI 300 is accessed by a user, so that the state of the overall workflow as represented by the progress bar and the progress indicator 304 and error indicator 308 are automatically and instantaneously updated.

In some embodiments, a user may select a particular step (which may or may not be the current step). The selected step may cause validation rules with respect to that step to be immediately executed and displayed in the screen. For example, if a user selected step 2 in GUI 300, then a message may be displayed stating that the time of day cannot be blank.

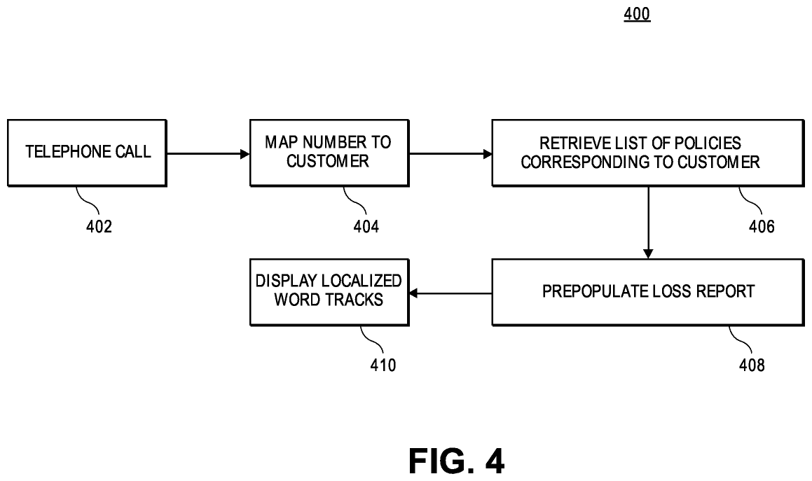

FIG. 4 depicts a flow diagram of a method 400 for displaying localized message (e.g., word tracks) to users based on user correlation using telephony data and loss report data. The method 400 may include receiving a telephone call (block 402). The telephone call may be initiated by a user seeking to file a loss report with an insurer/proprietor of the methods and systems described herein. The telephone call may be initiated by a client device (e.g., a mobile phone device) and may be received by a server (e.g., the server 104 of FIG. 1). The client device used to initiate the call may correspond to the client device 104 of FIG. 1. The method 400 may include an application, such as the loss reporting application 150 of FIG. 1 identifying the user by mapping the telephone number of the caller to a user profile (block 404). Such mapping may be accomplished mapping an identifier provided by the user and/or by the telephone number of the caller. Once the customer is identified, the method 400 may include retrieving a set of policies corresponding to the customer (block 406). If the set of policies includes multiple vehicles, the method 400 may include a disambiguation step, in which the method 400 prompts the user to uniquely identify the policy that is the subject of the user's call. Next, the method 400 may include prepopulating a loss report, wherein prepopulating the loss report includes inserting into entry fields in the loss report, values corresponding to the auto policy (e.g., the policy number, coverage, etc.) and/or the user (e.g., the user's name, address, etc.). The method 400 may further include displaying localized word tracks (block 410). Method 400 may speed up time that is required to start a loss report by automating customer identification, policy identification, and form filling steps that a customer service user currently must perform manually.

Further, the process of rendering aid to callers requires customer service users to review job aids that are hosted in separate loss intake applications. Further, the skillsets of customer service users may vary widely, including expertise and tenure from employee to employee. As such, in an embodiment, the method 400 may include a mechanism for identifying an employee/customer service user and providing only those word tracks that are needed to that user and/or omitting other word tracks which may be superfluous to a more experienced customer service user.

### III. Smart Scripting

As noted, the method 400 may route the caller to a customer service user. The customer service user may be using a second client device 102 coupled to server 104 locally and/or via the network 106. Once a telephone connection is established between the caller and the customer service user, the customer service user may access the loss reporting application 150, which may prompt the user to read one or more word tracks to the caller. In an embodiment, the method 400 may include Smart Scripting which may include selecting pre-localized word tracks based on the preferred language of the caller, or localizing canonical word tracks at runtime. For example, existing job info system may include a canonical English form of a direct call from consumer word track:

“Thank you <caller's name>. May I call you <caller's first name>? Please be aware our call may be monitored or recorded.

<Caller's preferred name>, I'm going to ask you some questions about what happened and its okay if you can't answer all of them:

As needed:
Are you calling to file a new claim for your vehicle or home?
(Auto only) Were you involved in an accident or did something else happen?
<Caller's preferred name>, I'm sorry to hear that this happened.
Are you insured with <Insurer name>?
What policy do you want to file this claim under?”

The job info system may also include a static version of the direct call from consumer word track in, for example, Spanish:

“Gracias <caller's name>. Lo/!a puedo llamar <caller's first name>? Le informo que nuestra flamada puede ser supervisada o grabada.

<Caller's preferred name>, le voy a hacer unas preguntas acerca de lo que sucedi6, y esta bien si no puede responder a todas.

As needed:
Esti llamando para presentar una reclamaciOn nueva para su vehiculo o vivienda?
(Auto only) Estuvo involucrado en un accidente o sucedio otra cosa?
<Caller's preferred name>, lamento saber que esto sucedio.
Esti usted asegurado con <Insurer name>?
Bajo cual pOliza desea presentar esta reclamacion?”

The method 400 may include transmitting the canonical English word track to one of a plurality of translator modules, which may return a translated version. For example, an in-house translation service or a third party translation application programming interface (API) may be used to retrieve translated versions at runtime. Because the word tracks are stored in canonical form, updating a message in every language is a simple as updating the canonical version. Further, there may be many thousands of word tracks, and maintaining a database of static word tracks may require a large amount of disk space. Therefore, canonicalizing the word tracks and translating them at runtime vastly reduces required disk space, and hardware needs.

After the word track is retrieved and/or translated, the word track may be provided directly to the customer service user in a display device of a mobile device such as the mobile device 102, eliminating the requirement from the perspective of the customer service user of searching in a job aid system for a particular word track. Further, an experience score may be associated with each “as needed” bullet and each customer service user may be assigned a dynamic customer service user experience score. Method 400 may include identifying the dynamic customer service user experience score, and the process of retrieving a canonical word track and/or translating the canonical word track may include retrieving only those “as needed” bullets whose respective experience score exceeds the dynamic customer service user experience score of the customer service user. In this way, a customer service user will be shown only those script prompts that are relevant to the customer service user's expertise, and the caller will only hear prompts in their language of choice.

Embodiments of the techniques described in the present disclosure may include any number of the following aspects, either alone or combination:

1. A method for classifying total loss of a vehicle based on claim characteristics, comprising: training, using a labeled data set, a machine learning model to classify a loss report with respect to a set of categories, receiving, via a processor, a user loss report associated with a policy, analyzing, using the trained machine learning model, the user loss report to classify the user loss report with respect to one of the set of categories; and when the one of the set of categories corresponds to a total loss category, storing an indication of total loss in association with the loss report in an electronic database.

2. The method of aspect 1, wherein analyzing the user loss report to classify the user loss report with respect to one of the set of categories includes determining a difference between the estimated cost to repair the vehicle and the actual cash value of the vehicle.

3. The method of aspect 1, further comprising: transmitting, via a processor, a user option set including a salvage, a title transfer, and a policy update; and receiving, via a processor, an indication of acceptance of one or more of the options in the user option set.

4. The method of aspect 1, wherein analyzing the user loss report to classify the user loss report with respect to one of the set of categories includes generating a numeric value representing the one of the set of categories, and comparing the numeric value representing the one of the set of categories to a threshold value.

5. A method for displaying loss report workflow progress information having a plurality of steps, the method comprising: dynamically displaying a plurality of steps, the steps corresponding to a workflow common to the steps, wherein one of the plurality of steps is an active step, dynamically displaying a progress indicator in one of a plurality of step locations in a progress bar display, each indicator in the one of the plurality of step locations corresponding to a one of the plurality of steps, the active step corresponding to the indicator in the one of the plurality of step corresponding to the current step, displaying a status indicator area and an action area depicting, respectively, a loss report summary and a textual status such that when the current step changes, the loss report summary and the textual status are updated relative to the prior step; and in response to a selection of a particular step, executing a set of validation rules with respect to the selected step and displaying the result of the executing.

6. A method for automating loss report taking from a user, comprising: receiving, via a processor, a loss report data set and a telephony data set from the user, correlating, based on the telephony data set and the loss report data set, the user to a set of policies and a user profile, determining, based on the user profile, a preferred language of the user, and displaying, in a display device viewable by a customer support user, a prepopulated loss report and at least one loss report word track written in the preferred language of the user, wherein the prepopulated loss report and at least one loss report word track are interpolated into predetermined locations in a loss report template.

7. The method of aspect 6, wherein displaying a prepopulated loss report and at least one loss report word track written in the preferred language of the user, wherein the prepopulated loss report and at least one loss report word track are interpolated into predetermined locations in a loss report template includes dynamically localizing the loss report word track from a canonicalized representation into the preferred language of the user.

8. A computer system configured to classify total loss of a vehicle based on claim characteristics, the system comprising one or more processors configured to: train, using a labeled data set, a machine learning model to classify a loss report with respect to a set of categories, receive, via one of the one or more processors, a user loss report associated with a policy, analyze, using the trained machine learning model, the user loss report to classify the user loss report with respect to one of the set of categories; and when the one of the set of categories corresponds to a total loss category, store an indication of total loss in association with the loss report in an electronic database.

9. The system of aspect 8, the one or more processors further configured to: determine a difference between the estimated cost to repair the vehicle and the actual cash value of the vehicle.

10. The system of aspect 8, the one or more processors further configured to: transmit, via a processor, a user option set including a salvage, a title transfer, and a policy update; and receive, via a processor, an indication of acceptance of one or more of the options in the user option set.

11. The system of aspect 8, the one or more processors further configured to: generate a numeric value representing the one of the set of categories, and comparing the numeric value representing the one of the set of categories to a threshold value.

12. A computer system configured to display loss report workflow progress information having a plurality of steps, the system comprising a display device and one or more processors configured to: dynamically display, in the display device, a plurality of steps, the steps corresponding to a workflow common to the steps, wherein one of the plurality of steps is an active step, dynamically display, in the display device, a progress indicator in one of a plurality of step locations in a progress bar display, each indicator in the one of the plurality of step locations corresponding to a one of the plurality of steps, the active step corresponding to the indicator in the one of the plurality of step corresponding to the current step, display, in the display device, a status indicator area and an action area depicting, respectively, a loss report summary and a textual status such that when the current step changes, the loss report summary and the textual status are updated relative to the prior step; and in response to a selection of a particular step, execute, via the one or more processors, a set of validation rules with respect to the selected step and displaying the result of the executing.

13. A computer system configured to automate loss report taking from a user, the system comprising a display device viewable by a customer support user and one or more processors configured to: receive, via the one or more processors, a loss report data set and a telephony data set from the user, correlate, based on the telephony data set and the loss report data set, the user to a set of policies and a user profile, determine, based on the user profile, a preferred language of the user, and display, in the display device viewable by the customer support user, a prepopulated loss report and at least one loss report word track written in the preferred language of the user, wherein the prepopulated loss report and at least one loss report word track are interpolated into predetermined locations in a loss report template.

14. The method of aspect 13, the one or more processors further configured to: dynamically localize the loss report word track from a canonicalized representation into the preferred language of the user.

15. A non-transitory computer readable medium containing program instructions that when executed, cause a computer to: receive, via one or more processors, a loss report data set and a telephony data set from the user, correlate, based on the telephony data set and the loss report data set, the user to a set of policies and a user profile, determine, based on the user profile, a preferred language of the user, and display, in a display device viewable by the customer support user, a prepopulated loss report and at least one loss report word track written in the preferred language of the user, wherein the prepopulated loss report and at least one loss report word track are interpolated into predetermined locations in a loss report template.

16. The non-transitory computer readable medium of aspect 15, comprising further program instructions that when executed cause a computer to: dynamically localize the loss report word track from a canonicalized representation into the preferred language of the user.

17. A non-transitory computer readable medium containing program instructions that when executed, cause a computer to: dynamically display, in a display device, a plurality of steps, the steps corresponding to a workflow common to the steps, wherein one of the plurality of steps is an active step, dynamically display, in the display device, a progress indicator in one of a plurality of step locations in a progress bar display, each indicator in the one of the plurality of step locations corresponding to a one of the plurality of steps, the active step corresponding to the indicator in the one of the plurality of step corresponding to the current step, display, in the display device, a status indicator area and an action area depicting, respectively, a loss report summary and a textual status such that when the current step changes, the loss report summary and the textual status are updated relative to the prior step; and in response to a selection of a particular step, execute, via one or more processors, a set of validation rules with respect to the selected step and displaying the result of the executing.

### ADDITIONAL CONSIDERATIONS

With the foregoing, any users (e.g., insurance customers) whose data is being collected and/or utilized may first opt-in to a rewards, insurance discount, or other type of program. After the user provides their affirmative consent, data may be collected from the user's device (e.g., client device 102 of FIG. 1). Of course, local storage and use of a trained ML model at a user device may have the benefit of removing any concerns of privacy or anonymity, by removing the need to send any personal or private data to a remote server (e.g., the server device 104 of FIG. 1). In such instances, there may be no need for affirmative consent from a user.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Unless a claim element is defined by reciting the word “means” and a function without the recital of any structure, it is not intended that the scope of any claim element be interpreted based upon the application of 35 U.S.C. § 112(f). The systems and methods described herein are directed to an improvement to computer functionality, and improve the functioning of conventional computers.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more modules of a computer system (e.g., a processor or a group of processors) may be configured by software (e.g., an application or application portion) as a module that operates to perform certain operations as described herein.

In various embodiments, a module may be implemented mechanically or electronically. Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment. In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for carrying out the methods and systems described herein through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein. It is therefore intended that the foregoing detailed description be regarded as illustrative rather than limiting, and that it be understood that it is the following claims, including all equivalents, that are intended to define the spirit and scope of this invention.

1. A computer-implemented method for classifying total loss of a vehicle based on claim characteristics, comprising:
training, using a labeled data set, a machine learning model to classify a loss report with respect to a set of categories, the machine learning model including a plurality of input parameters of an input layer of the machine learning model,
receiving, via a processor, a user loss report associated with a policy, the user loss report including a plurality of loss report inputs corresponding to respective steps in a loss report workflow,
analyzing, using the trained machine learning model, the user loss report to classify the user loss report with respect to one of the set of categories, each of the plurality of loss report inputs being analyzed by a respective one of the plurality of input parameters of the input layer of the machine learning model; and
when the one of the set of categories corresponds to a total loss category, storing an indication of total loss in association with the loss report in an electronic database.

2. The computer-implemented method of claim 1, wherein analyzing the user loss report to classify the user loss report with respect to one of the set of categories includes determining a difference between the estimated cost to repair the vehicle and the actual cash value of the vehicle.

3. The computer-implemented method of claim 1, further comprising:
transmitting, via a processor, a user option set including a salvage, a title transfer, and a policy update; and
receiving, via a processor, an indication of acceptance of one or more of the options in the user option set.

4. The computer-implemented method of claim 1, wherein analyzing the user loss report to classify the user loss report with respect to one of the set of categories includes generating a numeric value representing the one of the set of categories, and comparing the numeric value representing the one of the set of categories to a threshold value.

5. The computer-implemented method of claim 1, wherein the labeled data set includes a plurality of historical loss reports and a corresponding indication of whether the historical loss report is a total loss or not a total loss.

6. The computer-implemented method of claim 1, further comprising
correlating the user loss report associated with the policy to a user.

7. The computer-implemented method of claim 6, further comprising:
one or both of (i) determining the preferred language of the user, and (ii) selecting a template in the preferred language of the user.

8. The computer-implemented method of claim 1, wherein training, using the labeled data set, the machine learning model to classify the loss report with respect to the set of categories includes analyzing a database of vehicle types labeled by respective actual cash value.

9. The computer-implemented method of claim 1, wherein, when the one of the set of categories corresponds to the total loss category, storing the indication of total loss in association with the loss report in the electronic database includes one or both of (i) preparing the vehicle identified in the loss report for salvage, and (ii) transferring the title of the vehicle identified in the loss report to an insurer.

10. The computer-implemented method of claim 1, wherein, when the one of the set of categories corresponds to the total loss category, storing the indication of total loss in association with the loss report in the electronic database includes displaying a canonicalized word track to a user.

11. A computer system configured to classify total loss of a vehicle based on claim characteristics, the system comprising one or more processors configured to:
train, using a labeled data set, a machine learning model to classify a loss report with respect to a set of categories, the machine learning model including a plurality of input parameters of an input layer of the machine learning model,
receive, via one of the one or more processors, a user loss report associated with a policy, the user loss report including a plurality of loss report inputs corresponding to respective steps in a loss report workflow,
analyze, using the trained machine learning model, the user loss report to classify the user loss report with respect to one of the set of categories, each of the plurality of loss report inputs being analyzed by a respective one of the plurality of input parameters of the input layer of the machine learning model; and
when the one of the set of categories corresponds to a total loss category, store an indication of total loss in association with the loss report in an electronic database.

12. The system of claim 11, the one or more processors further configured to:
determine a difference between the estimated cost to repair the vehicle and the actual cash value of the vehicle.

13. The system of claim 11, the one or more processors further configured to:
transmit, via a processor, a user option set including a salvage, a title transfer, and a policy update; and
receive, via a processor, an indication of acceptance of one or more of the options in the user option set.

14. The system of claim 11, the one or more processors further configured to:
generate a numeric value representing the one of the set of categories, and comparing the numeric value representing the one of the set of categories to a threshold value.

15. The system of claim 11, the one or more processors further configured to:
one or both of (i) prepare the vehicle identified in the loss report for salvage, and (ii) transfer the title of the vehicle identified in the loss report to an insurer.

16. A non-transitory computer readable medium containing program instructions that when executed, cause a computer to:
train, using a labeled data set, a machine learning model to classify a loss report with respect to a set of categories, the machine learning model including a plurality of input parameters of an input layer of the machine learning model,
receive, via one of the one or more processors, a user loss report associated with a policy, the user loss report including a plurality of loss report inputs corresponding to respective steps in a loss report workflow,
analyze, using the trained machine learning model, the user loss report to classify the user loss report with respect to one of the set of categories, each of the plurality of loss report inputs being analyzed by a respective one of the plurality of input parameters of the input layer of the machine learning model; and
when the one of the set of categories corresponds to a total loss category, store an indication of total loss in association with the loss report in an electronic database.

17. The non-transitory computer readable medium of claim 16 containing further program instructions that when executed, cause a computer to:
determine a difference between the estimated cost to repair the vehicle and the actual cash value of the vehicle.

18. The non-transitory computer readable medium of claim 16 containing further program instructions that when executed, cause a computer to:
transmit, via a processor, a user option set including a salvage, a title transfer, and a policy update; and
receive, via a processor, an indication of acceptance of one or more of the options in the user option set.

19. The non-transitory computer readable medium of claim 16 containing further program instructions that when executed, cause a computer to:
generate a numeric value representing the one of the set of categories, and comparing the numeric value representing the one of the set of categories to a threshold value.

20. The non-transitory computer readable medium of claim 16 containing further program instructions that when executed, cause a computer to:
one or both of (i) prepare the vehicle identified in the loss report for salvage, and (ii) transfer the title of the vehicle identified in the loss report to an insurer.
